(19) United States
(12) Patent Application Publication
(10) Pub. No.: US 2021/0300132 A1
(43) Pub. Date: Sep. 30, 2021

(54) TIRE STATE ESTIMATION SYSTEM AND METHOD UTILIZING A PHYSICS-BASED TIRE MODEL

(71) Applicant: Bridgestone Americas Tire Operations, LLC, Nashville, TN (US)

(72) Inventor: Thomas A. Sams, Hartville, OH (US)

(21) Appl. No.: 17/198,784

(22) Filed: Mar. 11, 2021

Related U.S. Application Data
(60) Provisional application No. 62/994,870, filed on Mar. 26, 2020.

(51) Int. Cl. B60C 23/04; G06F 30/23; B60C 23/00

(52) U.S. Cl. CPC B60C 23/0488; G06F 2111/10; B60C 23/002; G06F 30/23

(57) ABSTRACT

A computer-implemented method is provided for tire state estimation using a physics-based model rather than empirical models. During a calibration process, data is collected in data storage as correlating a first set of tire acceleration values for a given tire model to respective known values for each of a plurality of tire state variables. A physics-based tire model is generated corresponding to the given tire model and comprising one or more tire model parameters determined upon calibration and which remain constant under different conditions. During operation of the tire, measurements are collected for a second set of tire acceleration values and certain of the tire state variables (e.g., speed and inflation) via one or more tire-mounted sensors. At least one of the unmeasured tire state variables (e.g., load and/or tread depth) is estimated based on the second set of tire acceleration values and using the physics-based tire model.

### CROSS-REFERENCES TO RELATED APPLICATIONS

This application claims benefit of U.S. Provisional Patent Application No. 62/994,870, filed Mar. 26, 2020, and which is hereby incorporated by reference in its entirety.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### FIELD OF THE INVENTION

The present invention relates generally to estimation and prediction of tire state for wheeled vehicles. More particularly, an embodiment of an invention as disclosed herein relates to systems and methods for using physics-based models in the characterization and prediction of states and conditions for tires of wheeled vehicles including but not limited to motorcycles, consumer vehicles (e.g., passenger and light truck), commercial and off-road (OTR) vehicles.

### BACKGROUND

Prediction of tire wear is an important tool for anyone owning or operating vehicles, particularly in the context of fleet management. As tires are used, it is normal for the tread to gradually become shallower and overall tire performance to change. At a certain point it becomes critical to be aware of the tire conditions, as insufficient tire tread can create unsafe driving conditions. For example, when road conditions are non-optimal the tires may be unable to grip the road and a driver may lose control of his or her vehicle. Generally stated, the shallower the tire tread, the more easily the driver may lose traction when driving in rain, snow, or the like.

In addition, irregular tread wear may occur for a variety of reasons that may lead users to replace a tire sooner than would otherwise have been necessary. Vehicles, drivers, and individual tires are all different from each other, and can cause tires to wear at very different rates. For instance, high performance tires for sports cars wear more quickly than touring tires for a family sedan. However, a wide variety of factors can cause a tire to wear out sooner than expected, and/or cause it to wear irregularly and create noise or vibration. Two common causes of premature and/or irregular tire wear are improper inflation pressure and out-of-spec alignment conditions.

More generally, estimating the state of the tire at any given time (load, speed, tread depth, etc.) is of great value to the end user, and can also be used to feed into other active safety units or an equivalent on the vehicle such as automatic braking systems (ABS), electronic stability control (ESC), etc. For fleet management applications, particularly those involving autonomous vehicle fleets, real-time knowledge regarding the capacities of a vehicle's tires will be critical to ensuring that the vehicle can make certain maneuvers. For ride sharing applications, it will also be vital that the tread depth of the tires is known since the passengers of the vehicles will not be liable to maintain the vehicle or its tires.

One current priority in the tire industry is towards tire-mounted sensors (TMS), wherein a sensor is adhered to the inner liner of the tire. Such sensors typically comprise a temperature and pressure sensor and an accelerometer as well as a unique identifier for the tire. Having an accelerometer placed on the inner liner of the tire has proven to be a dependable way to identify the tire state. However, previous methods that estimate tire states or tire conditions from TMS accelerometer data have traditionally utilized empirical models.

### BRIEF SUMMARY

An embodiment of a computer-implemented method as disclosed herein uses a physics-based model of the tire to determine the tire's current state or condition, instead of implementing empirical models in accordance with the prior art. Initially, calibration data is collected in data storage, said calibration data correlating a first set of tire acceleration values for a given tire model to respective known values for each of a plurality of tire state variables. A physics-based tire model is generated corresponding to the given tire model. From the initial calibration data, one or more tire model parameters which remain constant under different conditions are determined. A second set of tire acceleration values and one or more of the plurality of tire state variables are subsequently measured via one or more sensors associated with a first tire of the given tire model, after which at least a different one of the plurality of tire state variables may be estimated based on the measured second set of tire acceleration values and using the physics-based tire model.

In one exemplary aspect of the aforementioned embodiment, the measured one or more of the plurality of tire state variables comprises a tire inflation value and a tire rotational rate, and the estimated at least a different one of the plurality of tire state variables comprises a load bearing on the first tire. The estimated load may for example correspond to an optimal fit over an entire profile associated with the second set of tire acceleration values.

The estimated at least a different one of the plurality of tire state variables may further comprise a tire tread. The estimated tire tread may for example correspond to an optimal fit of a rate of acceleration proximate a footprint region associated with a profile for the second set of tire acceleration values.

In another exemplary aspect of the aforementioned embodiment, the physics-based tire model is generated as a flexible ring, corresponding to a tire belt package, on an elastic foundation of radial springs corresponding to a tire carcass.

In another exemplary aspect of the aforementioned embodiment, the first set of tire acceleration values is generated for calibration via an accelerometer mounted to a tire, the tire further loaded against a physical surface. Alternatively, the first set of tire acceleration values may be generated for calibration via finite element analysis of the given tire model.

In another exemplary aspect of the aforementioned embodiment, one or more tire traction characteristics for the tire may be predicted, based at least on the measured and estimated tire state variables. The one or more predicted tire traction characteristics may be provided to an active safety unit associated with the vehicle, wherein the active safety unit is configured to modify one or more vehicle operation settings based on at least the predicted one or more tire traction characteristics.

In another embodiment, a system for tire state estimation as disclosed herein may include a data storage network having calibration data stored thereon. The calibration data respectively correlates at least one set of tire acceleration values for each of a plurality of types of tires to known values for each of a plurality of tire state variables. The data storage further includes a plurality of physics-based tire models corresponding to the given types of tires and comprising one or more tire model parameters determined upon calibration and which remain constant under different conditions. For each of a plurality of vehicles, at least one computing node is linked to at least a tire-mounted sensor for a first tire and configured to collect a real-time set of tire acceleration values and real-time values for one or more of the plurality of tire state variables. A server-based computing network is further provided and configured to select one of the plurality of physics-based tire models based at least on a tire type of the first tire, and to estimate at least a different one of the plurality of tire state variables based on the measured real-time set of tire acceleration values and using the selected physics-based tire model.

### BRIEF DESCRIPTION OF THE SEVERAL VIEWS OF THE DRAWINGS

Hereinafter, embodiments of the invention are illustrated in more detail with reference to the drawings.

FIG. 1 is a block diagram representing an exemplary embodiment of a system for tire state estimation as disclosed herein.

FIG. 2 is a graphical diagram representing an exemplary output from a physics-based model as disclosed herein relating to tire ring deformation due to loading.

FIG. 3 is a graphical diagram representing an exemplary output from a physics-based model as disclosed herein relating to tire radial acceleration under different loads.

FIG. 4 is a graphical diagram representing an exemplary output from a physics-based model as disclosed herein relating to tire tangential acceleration under different loads.

FIG. 5 is a flowchart representing an embodiment of a tire state estimation method as disclosed herein.

FIG. 6A is a graphical diagram representing an exemplary set of radial acceleration data as an input to a ring model in an embodiment of the system and method as disclosed herein.

FIG. 6B is a graphical diagram representing an exemplary ring model in an embodiment of the system and method as disclosed herein.

FIG. 6C is a graphical diagram representing an exemplary plotting of measured radial acceleration data against corresponding model output.

FIG. 7 is a graphical diagram representing exemplary load predictions based on plots of measured radial acceleration data and a corresponding model output, for known values of speed and tread depth.

FIG. 8 is a graphical diagram representing exemplary tread depth predictions based on plots of measured radial acceleration data and a corresponding model output, for a known value of speed and an unknown load.

### DETAILED DESCRIPTION

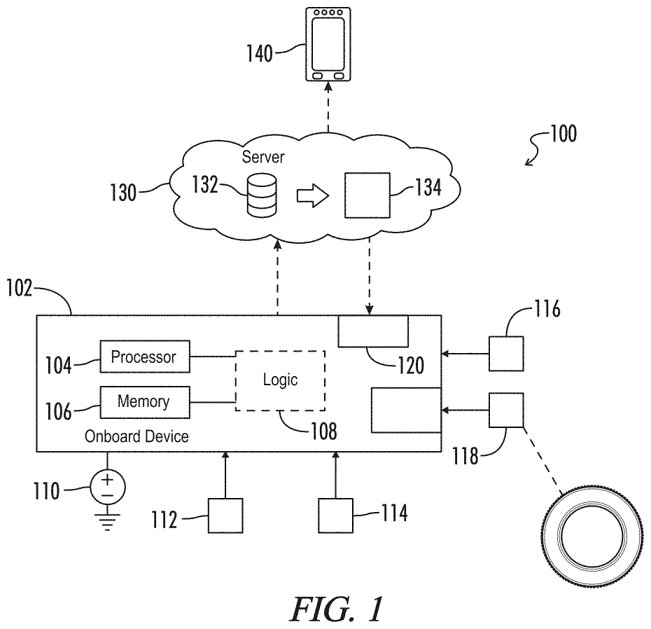

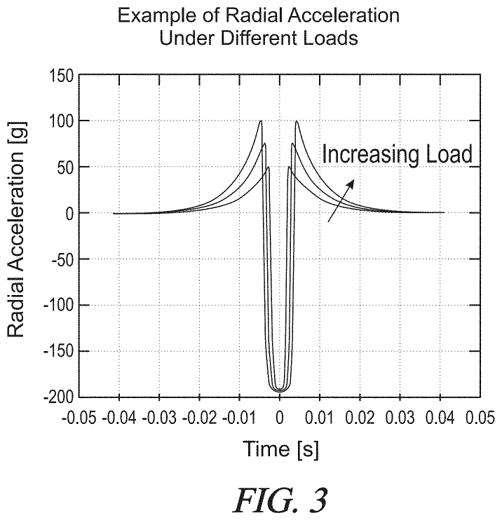

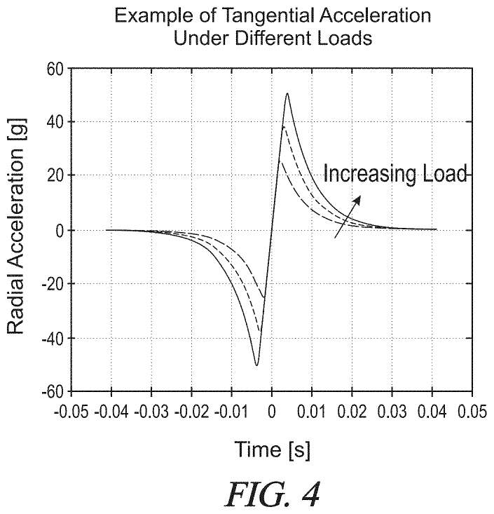

Referring generally to FIGS. 1-8, various exemplary embodiments of an invention may now be described in detail. Where the various figures may describe embodiments sharing various common elements and features with other embodiments, similar elements and features are given the same reference numerals and redundant description thereof may be omitted below.

This invention details a system and method using a physics-based model of the tire to determine the tire's current state.

Various embodiments of a system as disclosed herein may include centralized computing nodes (e.g., a cloud server) in functional communication with a plurality of distributed data collectors and computing nodes (e.g., associated with individual vehicles) for effectively implementing models as disclosed herein. Referring initially to FIG. 1, an exemplary embodiment of the system 100 includes a computing device 102 that is onboard a vehicle and configured to at least obtain data and transmit said data to a remote server 130 and/or perform relevant computations as disclosed herein. The computing device may be portable or otherwise modular as part of a distributed vehicle data collection and control system (as shown), or otherwise may be integrally provided with respect to a central vehicle data collection control system (not shown). The device may include a processor 104 and memory 106 having program logic 108 residing thereon. Generally stated, a system as disclosed herein may implement numerous components distributed across one or more vehicles, for example but not necessarily associated with a fleet management entity, and further a central server or server network in functional communication with each of the vehicles via a communications network. The vehicle components may typically include one or more sensors such as, e.g., vehicle body accelerometers, gyroscopes, inertial measurement units (IMU), position sensors such as global positioning system (GPS) transponders 112, tire pressure monitoring system (TPMS) sensor transmitters 118 and associated onboard receivers, or the like, as linked for example to a controller area network (CAN) bus network and providing signals thereby to local processing units. The illustrated embodiment includes for illustrative purposes, without otherwise limiting the scope of the present invention thereby, an ambient temperature sensor 116, an engine sensor 114 configured for example to provide sensed barometric pressure signals, and a DC power source 110.

In view of the following discussion, other sensors for collecting and transmitting vehicle data such as pertaining to velocity, acceleration, braking characteristics, or the like will become sufficiently apparent to one of ordinary skill in the art and are not further discussed herein. Various bus interfaces, protocols, and associated networks are well known in the art for the communication of vehicle kinetics data or the like between the respective data source and the local computing device, and one of skill in the art would recognize a wide range of such tools and means for implementing the same.

The system may include additional distributed program logic such as for example residing on a fleet management server or other user computing device 140, or a user interface of a device resident to the vehicle or associated with a driver thereof (not shown) for real-time notifications (e.g., via a visual and/or audio indicator), with the fleet management device in some embodiments being functionally linked to the onboard device via a communications network. System programming information may for example be provided on-board by the driver or from a fleet manager.

Vehicle and tire sensors may in an embodiment further be provided with unique identifiers, wherein the onboard device processor 104 can distinguish between signals provided from respective sensors on the same vehicle, and further in certain embodiments wherein a central server 130 and/or fleet maintenance supervisor client device 140 may distinguish between signals provided from tires and associated vehicle and/or tire sensors across a plurality of vehicles. In other words, sensor output values may in various embodiments be associated with a particular tire, a particular vehicle, and/or a particular tire-vehicle system for the purposes of onboard or remote/downstream data storage and implementation for calculations as disclosed herein. The onboard device processor may communicate directly with the hosted server as shown in FIG. 1, or alternatively the driver's mobile device or truck-mounted computing device may be configured to receive and process/transmit onboard device output data to the hosted server and/or fleet management server/device.

Signals received from a particular vehicle and/or tire sensor may be stored in onboard device memory, or an equivalent data storage unit functionally linked to the onboard device processor, for selective retrieval as needed for calculations according to the method disclosed herein. In some embodiments, raw data signals from the various signals may be communicated substantially in real time from the vehicle to the server. Alternatively, particularly in view of the inherent inefficiencies in continuous data transmission of high frequency data, the data may for example be compiled, encoded, and/or summarized for more efficient (e.g., periodic time-based or alternatively defined event-based) transmission from the vehicle to the remote server via an appropriate communications network.

The vehicle data and/or tire data, once transmitted via a communications network to the hosted server 130, may be stored for example in a database 132 associated therewith. The server may include or otherwise be associated with tire state models 134 and optionally additional models such as tire traction models for selectively retrieving and processing the vehicle data and/or tire data as appropriate inputs. The models may be implemented at least in part via execution of a processor, enabling selective retrieval of the vehicle data and/or tire data and further in electronic communication for the input of any additional data or algorithms from a database, lookup table, or the like that is stored in association with the server.

The vehicle data and/or tire data, once transmitted via a communications network to the hosted server, may be stored for example in a database associated therewith. The server may include or otherwise be associated with at least tire wear models for selectively retrieving and processing the vehicle data and/or tire data as appropriate inputs. The models may be implemented at least in part via execution of a processor, enabling selective retrieval of the vehicle data and/or tire data and further in electronic communication for the input of any additional data or algorithms from a database, lookup table, or the like that is stored in association with the server.

In an embodiment, an estimated or predicted tire state may be provided as an output from the model to one or more downstream models or applications. For example, a predicted tread depth status may be generated as feedback or feed-forward signals to a vehicular control system, a traction model (in the same system or as part of another system functionally linked thereto), and/or another predictive model associated with fuel efficiency, durability, or the like. The tire state information (e.g., tread depth) may for example be provided along with certain vehicle data as inputs to the traction model, which may be configured to provide an estimated traction status or one or more traction characteristics for the respective tire. An exemplary traction model may comprise “digital twin” virtual representations of physical parts, processes or systems wherein digital and physical data are paired and combined with learning systems such as for example artificial neural networks. Real vehicle data and/or tire data from a particular tire, vehicle or tire-vehicle system may be provided throughout the life cycle of the respective asset to generate a virtual representation of the vehicle tire for estimation of tire traction, wherein subsequent comparison of the estimated tire traction with a corresponding measured or determined actual tire traction may preferably be implemented as feedback for machine learning algorithms executed at the server level.

An exemplary traction model may further utilize the results from prior testing, including for example stopping distance testing results, tire traction testing results, etc., as collected with respect to numerous tire-vehicle systems and associated combinations of tire state values for input parameters (e.g., tire tread, inflation pressure, road surface characteristics, vehicle speed and acceleration, slip rate and angle, normal force, braking pressure and load), wherein a tire traction output may be effectively predicted for a given set of current vehicle data and tire data inputs.

In one embodiment, the outputs from this traction model may be incorporated into an active safety system, an autonomous fleet management system, or the like. As previously noted, data may be collected from sensors on the vehicle to feed into the tire wear model which will predict tread depth, and this data may further be fed into a traction model. The term “active safety systems” as used herein may preferably encompass such systems as are generally known to one of skill in the art, including but not limited to examples such as collision avoidance systems, advanced driver-assistance systems (ADAS), anti-lock braking systems (ABS), etc., which can be configured to utilize the traction model output information to achieve optimal performance. For example, collision avoidance systems are typically configured to take evasive action, such as automatically engaging the brakes of a host vehicle to avoid or mitigate a potential collision with a target vehicle, and enhanced information regarding the traction capabilities of the tires and accordingly the braking capabilities of the tire-vehicle system are eminently desirable.

As represented for example in FIG. 1, a feedback signal corresponding to the predicted tire wear status (e.g., predicted tread depth at a given distance, time, or the like) may be provided via an interface 120 to an onboard device 102 associated with the vehicle itself, or to a mobile device 140 associated with a user, such as for example integrating with a user interface configured to provide alerts or notice/recommendations that a tire should or soon will need to be replaced.

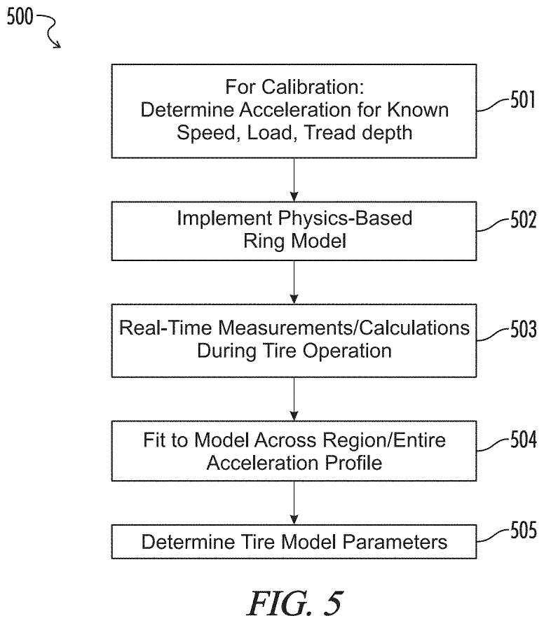

Referring next to FIG. 5, an exemplary embodiment of a method 500 for determining the current state or condition of a tire may be implemented as follows.

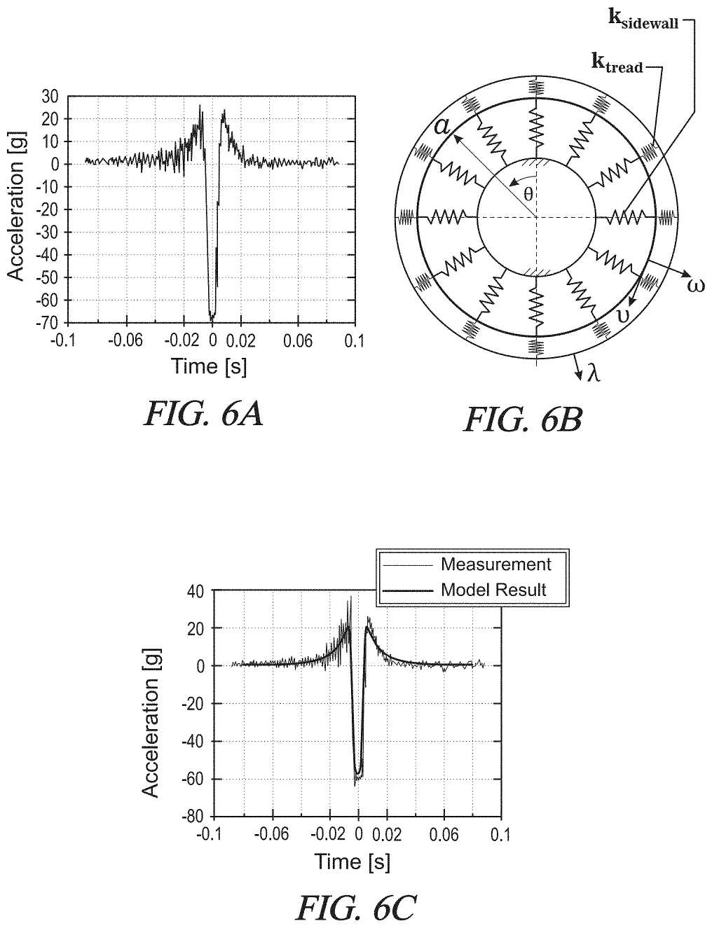

First, an initial calibration may be performed (step 501). This can for example be provided once for a given tire specification on a drum. The calibration process may involve running the tire with an accelerometer attached to the inner liner and collecting data at known parameters including load, speed, pressure, tread depth, and the like. This physical test could also be replaced in certain embodiments with finite element simulations of the tire. An example of radial acceleration data with respect to time as generated during the calibration procedure is illustrated in FIG. 6A.

A physics-based model as disclosed herein may be selected in accordance with a type of tire (step 502). An embodiment of the physics-based tire model is illustrated in FIG. 6B, and is for example developed by two-dimensional modeling of the tire as a flexible ring on an elastic foundation (REF). The tire belt package is modeled as a flexible ring, the tread is modeled as continuous radial springs, and the carcass is modeled as a foundation of radial springs. The model has several variables related to the tire structure (such as the stiffness values associated with these different springs), as well as the condition of the tire (such as load, pressure, speed, tread depth, etc.).

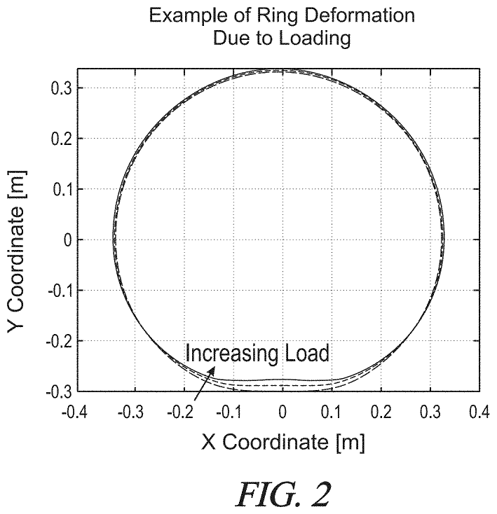

The model may be loaded against a flat or curved surface (e.g., a road or drum), wherein radial deformation response of the ring may be calculated. In certain embodiments, deformation response may be further analyzed in accordance with changes to one or more of load, pressure, speed, tread depth, and the like. From the determined deformation, the steady-state acceleration is able to be easily extracted. FIGS. 2, 3, and 4 illustrate exemplary plots of the model's output under different loads, corresponding to the ring deformation, radial acceleration, and tangential acceleration, respectively.

From the initial calibration, the tire model parameters which remain constant under different conditions can be identified and/or algorithmically determined.

Next, using the tire model parameters identified in the calibration step, the selected model may be used to estimate the most likely state/condition of the tire. In subsequent steps, one or more vehicle mounted sensors (TMS) or equivalent devices may measure certain tire state variables such as, e.g., tire inflation pressure. The speed can be determined by, e.g., collecting multiple rotations of data and finding the rotational rate of the tire, thereby leaving only the tread depth and load to be estimated or predicted. Also, since the tread depth does not change rapidly over time, some assumptions can be made to achieve better predictions.

In an embodiment, the load may be estimated by finding the optimal fit over the entire acceleration profile, whereas the tread depth may be estimated by finding the optimal fit of the jerk (rate of acceleration) over only the region where the tire begins to enter and leave the footprint. Referring for example to FIG. 6C, the model may produce a result that is very close to measured data.

While figures as referenced herein may show only the radial acceleration data, it should be noted that various embodiments of a physics-based model as disclosed herein may predict all three acceleration directions (as well as velocities, deformations, etc.), so the model is not limited to just radial acceleration and the examples provided herein should not be considered as limiting the scope of the present invention unless otherwise specifically stated.

The methodology and associated algorithms as disclosed herein for tire state estimation or prediction may be achieved by using a simple optimization routine to determine the optimal tire state/condition, or a more advanced and computation-intensive echnique such as using nonlinear filtering techniques (e.g. Extended Kalman Filter, Unscented Kalman Filter, etc.).

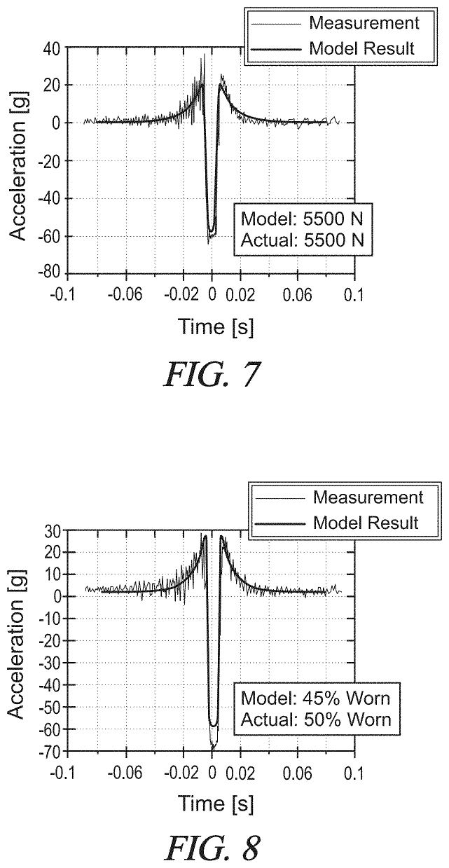

An embodiment of this method was used on a tire tested on a drum with an accelerometer attached to the inner liner. Referring next to FIGS. 7 and 8, a physics-based model and associated method was implemented to predict the correct load and tread depth to within less than 10% error. For the load estimation (FIG. 7), the model predicted 5500 N, wherein the true load was 5900 N (an error of 6.7%). For the tread depth (FIG. 8), the model estimated that the tread had been worn by 45%, where the true tread wear was 50% (5% error).

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable medium known in the art. An exemplary computer-readable medium can be coupled to the processor such that the processor can read information from, and write information to, the memory/storage medium. In the alternative, the medium can be integral to the processor. The processor and the medium can reside in an ASIC. The ASIC can reside in a user terminal. In the alternative, the processor and the medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Whereas certain preferred embodiments of the present invention may typically be described herein with respect to tire wear estimation for fleet management systems and more particularly for autonomous vehicle fleets or commercial trucking applications, the invention is in no way expressly limited thereto and the term “vehicle” as used herein unless otherwise stated may refer to an automobile, truck, or any equivalent thereof, whether self-propelled or otherwise, as may include one or more tires and therefore require accurate estimation or prediction of tire wear and potential disabling, replacement, or intervention in the form of for example direct vehicle control adjustments.

The term “user” as used herein unless otherwise stated may refer to a driver, passenger, mechanic, technician, fleet management personnel, or any other person or entity as may be, e.g., associated with a device having a user interface for providing features and steps as disclosed herein.

The previous detailed description has been provided for the purposes of illustration and description. Thus, although there have been described particular embodiments of a new and useful invention, it is not intended that such references be construed as limitations upon the scope of this invention except as set forth in the following claims.

What is claimed is:

1. A computer-implemented tire state estimation method comprising:
collecting calibration data in data storage, said calibration data correlating a first set of tire acceleration values for a given type of tire to respective known values for each of a plurality of tire state variables;
generating a physics-based tire model corresponding to the given type of tire and comprising one or more tire model parameters determined upon calibration and which remain constant under different conditions;
measuring a second set of tire acceleration values and one or more of the plurality of tire state variables via one or more sensors associated with a first tire of the given type of tire; and
estimating at least a different one of the plurality of tire state variables based on the measured second set of tire acceleration values and using the physics-based tire model.

2. The method of claim 1, wherein the measured one or more of the plurality of tire state variables comprises a tire inflation value and a tire rotational rate, and the estimated at least a different one of the plurality of tire state variables comprises a load bearing on the first tire.

3. The method of claim 2, wherein the estimated load corresponds to an optimal fit over an entire profile associated with the second set of tire acceleration values.

4. The method of claim 2, wherein the estimated at least a different one of the plurality of tire state variables further comprises a tire tread.

5. The method of claim 4, wherein the estimated tire tread corresponds to an optimal fit of a rate of acceleration proximate a footprint region associated with a profile for the second set of tire acceleration values.

6. The method of claim 1, wherein the physics-based tire model is generated as a flexible ring, corresponding to a tire belt package, on an elastic foundation of radial springs corresponding to a tire carcass.

7. The method of claim 1, wherein the first set of tire acceleration values is generated for calibration via an accelerometer mounted to a tire, the tire further loaded against a physical surface.

8. The method of claim 1, wherein the first set of tire acceleration values is generated for calibration via finite element analysis of the given type of tire.

9. The method of claim 1, further comprising predicting one or more tire traction characteristics for the tire, based at least on the measured and estimated tire state variables.

10. The method of claim 9, further comprising:
providing the one or more predicted tire traction characteristics to an active safety unit associated with the vehicle,
wherein the active safety unit is configured to modify one or more vehicle operation settings based on at least the predicted one or more tire traction characteristics.

11. A system for tire state estimation, comprising:
a data storage network having stored thereon calibration data respectively correlating at least one set of tire acceleration values for each of a plurality of types of tires to known values for each of a plurality of tire state variables, and a plurality of physics-based tire models corresponding to the given types of tires and comprising one or more tire model parameters determined upon calibration and which remain constant under different conditions;
for each of a plurality of vehicles, at least one computing node linked to at least a tire-mounted sensor for a first tire and configured to collect a real-time set of tire acceleration values and real-time values for one or more of the plurality of tire state variables;
a server-based computing network comprising computer readable media having instructions residing thereon and executable by one or more processors, the server network configured to
select one of the plurality of physics-based tire models based at least on a tire type of the first tire; and
estimating at least a different one of the plurality of tire state variables based on the measured real-time set of tire acceleration values and using the selected physics-based tire model.

12. The system of claim 11, wherein the measured real-time values for the one or more of the plurality of tire state variables comprises a tire inflation value and a tire rotational rate, and the estimated at least a different one of the plurality of tire state variables comprises a load bearing on the first tire.

13. The system of claim 12, wherein the estimated load corresponds to an optimal fit over an entire profile associated with the real-time set of tire acceleration values.

14. The system of claim 12, wherein the estimated at least a different one of the plurality of tire state variables further comprises a tire tread.

15. The system of claim 14, wherein the estimated tire tread corresponds to an optimal fit of a rate of acceleration proximate a footprint region associated with a profile for the real-time set of tire acceleration values.

16. The system of claim 11, wherein each of the stored plurality of physics-based tire models comprises a flexible ring corresponding to a tire belt package on an elastic foundation of radial springs corresponding to a tire carcass.

17. The system of claim 11, wherein for each of the types of tires, the stored set of tire acceleration values is generated for calibration via an accelerometer mounted to a tire of the given type, the tire further loaded against a physical surface.

18. The system of claim 11, wherein for each of the types of tires, the stored set of tire acceleration values is generated for calibration via finite element analysis of the given type of tire.

19. The system of claim 11, wherein the server-based computing network is further configured to:
predict one or more tire traction characteristics for the first tire, based at least on the measured and estimated tire state variables.

20. The system of claim 19, wherein the server-based computing network is configured to:
provide the one or more predicted tire traction characteristics to an active safety unit associated with the vehicle,
wherein the active safety unit is configured to modify one or more vehicle operation settings based on at least the predicted one or more tire traction characteristics.
